(19) United States
(12) Patent Application Publication
(10) Pub. No.: US 2014/0314189 A1
(43) Pub. Date: Oct. 23, 2014

(54) RECEIVER

(71) Applicant: NTT DOCOMO, INC., Chiyoda-ku (JP)

(72) Inventors: Yuta Sagae, Tokyo (JP); Yusuke Ohwatari, Tokyo (JP); Nobuhiko Miki, Tokyo (JP)

(73) Assignee: NTT DOCOMO, INC., Chiyoda-ku (JP)

(21) Appl. No.: 14/354,009

(22) PCT Filed: Nov. 2, 2012
(86) PCT No.: PCT/JP2012/078470

§ 371 Date: Apr. 24, 2014

(30) Foreign Application Priority Data
Nov. 4, 2011 (JP) 2011-242911

(51) Int. Cl. H04L 1/06; H04L 25/02

(52) U.S. Cl. CPC H04L 1/0606; H04L 25/021
USPC 375/346

(57) ABSTRACT

Provided is a receiver to improve the accuracy of estimating a covariance matrix R_{I+N} based on a data signal. In an IRC receiver 10 according to the present invention, a data signal is configured to be transmitted in an SFBC pair including two resource elements, an estimated covariance matrix R_{I+N} is configured to include a first covariance matrix R_{I+N} (2m) including a desired signal component in even-numbered resource elements in the SFBC pair and a second covariance matrix R_{I+N} (2m+1) including a desired signal component in odd-numbered resource elements in the space frequency block coding scheme unit, and a covariance matrix averaging unit 13 and a covariance matrix generation unit 16 are configured to perform, as the aforementioned predetermined process, an averaging process on each of elements in the first covariance matrix R_{I+N} (2m) and elements in the second covariance matrix R_{I+N} (2m+1).

### TECHNICAL FIELD

The present invention relates to a receiver.

### BACKGROUND ART

In an LTE (Long Term Evolution) scheme, in a downlink, as one of methods of improving cell-edge throughput, an IRC (Interference Rejection Combining) receiver is discussed which suppresses a beam of another mobile station UE causing interference.

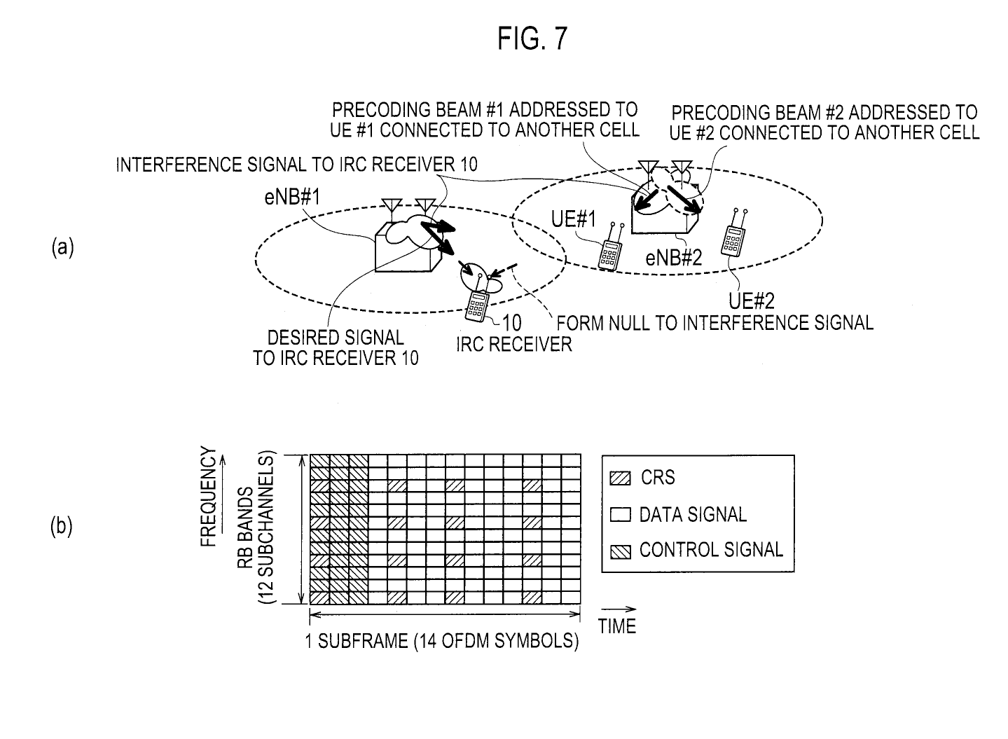

As illustrated in FIG. 7(a), an object of an IRC receiver 10 is to improve the reception quality of a desired signal while suppressing an interference signal.

Furthermore, an LTE (Release-8) scheme is so configured that in order to perform estimation of a channel state (CSI: Channel State Information), to demodulate a data signal and a control signal, and to measure reception quality in a cell, CRS (Cell-Specific Reference Signal) is transmitted.

Specifically, in the LTE (Release-8) scheme, the CRS is configured to be transmitted together with a data signal and a control signal by a configuration illustrated in FIG. 7(b). It is noted that it is possible to set the CRS to a maximum of four antennas.

Furthermore, in the LTE scheme, an SFBC (Space Frequency Block Coding) scheme is configured to be used as a transmit diversity scheme.

Furthermore, “Alamouti coding” capable of obtaining maximum diversity gain corresponding to maximum ratio combining at a symbol level is configured to be used. That is, coding is configured to be performed using two resource elements (REs: Resource Elements) in a frequency direction. In the present specification, the two resource elements are called an “SFBC pair”.

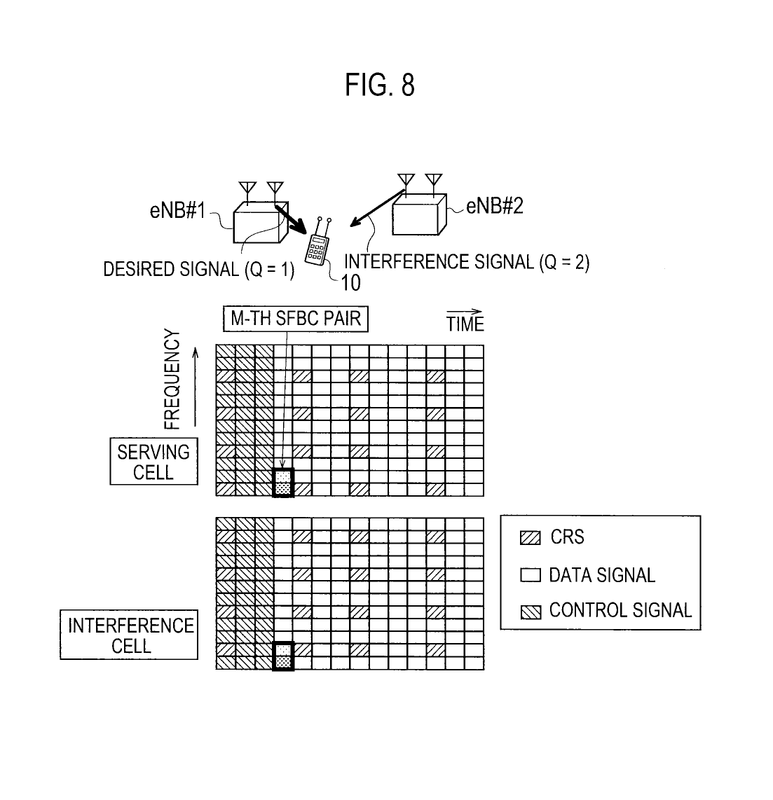

Hereinafter, as illustrated in FIG. 8, a description will be provided for a received signal model in the IRC receiver 10 when channel variation is ignored in the case in which the IRC receiver 10 receives a desired signal from a cell 1 (q=1) and receives an interference signal from a cell 2 (q=2).

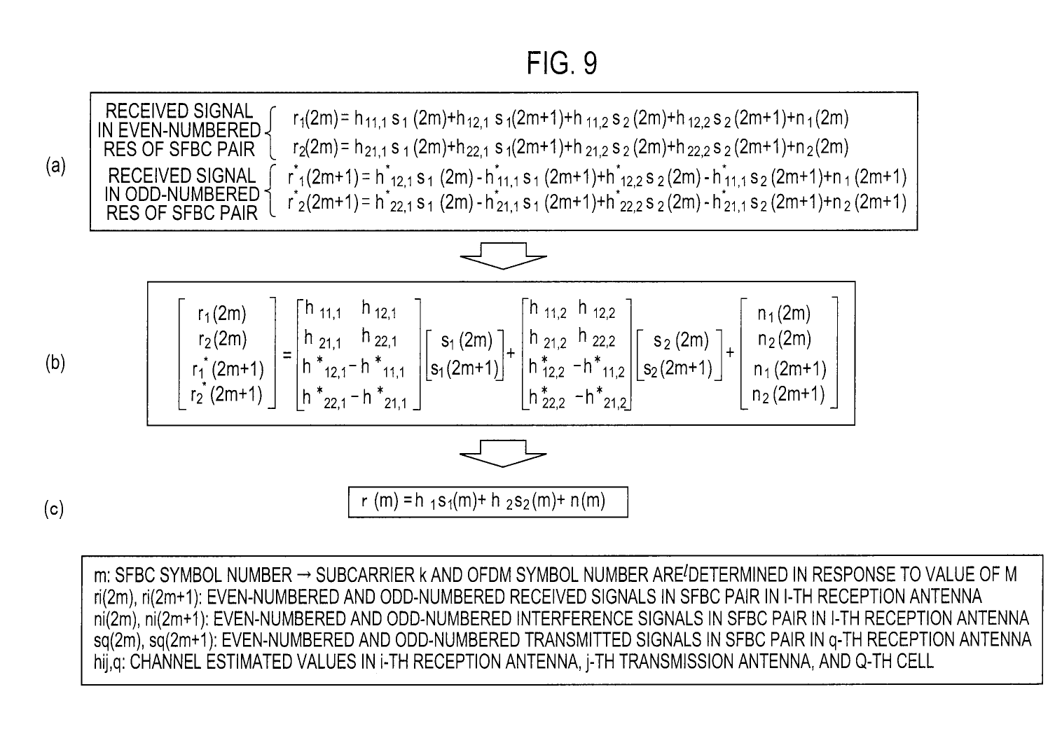

Specifically, according to Equations illustrated in FIG. 9(a) to FIG. 9(c), it is possible to express a received signal r₁ (2m) in even-numbered resource elements of an SFBC pair m in a reception antenna 1 (i=1) of the IRC receiver 10, a received signal r₂ (2m) in even-numbered resource elements of an SFBC pair m in a reception antenna 2 (i=2) of the IRC receiver 10, a received signal r₁* (2m+1) in odd-numbered resource elements of the SFBC pair m in the reception antenna 1 (i=1) of the IRC receiver 10, and a received signal r₂* (2m+1) in odd-numbered resource elements of the SFBC pair m in the reception antenna 2 (i=2) of the IRC receiver 10. Furthermore, “*” indicates a complex conjugate.

Furthermore, conventionally, in order to suppress interference, a technology for performing a reception process by using an MMSE (Minimum Mean Square Error) spatial filtering scheme has been known.

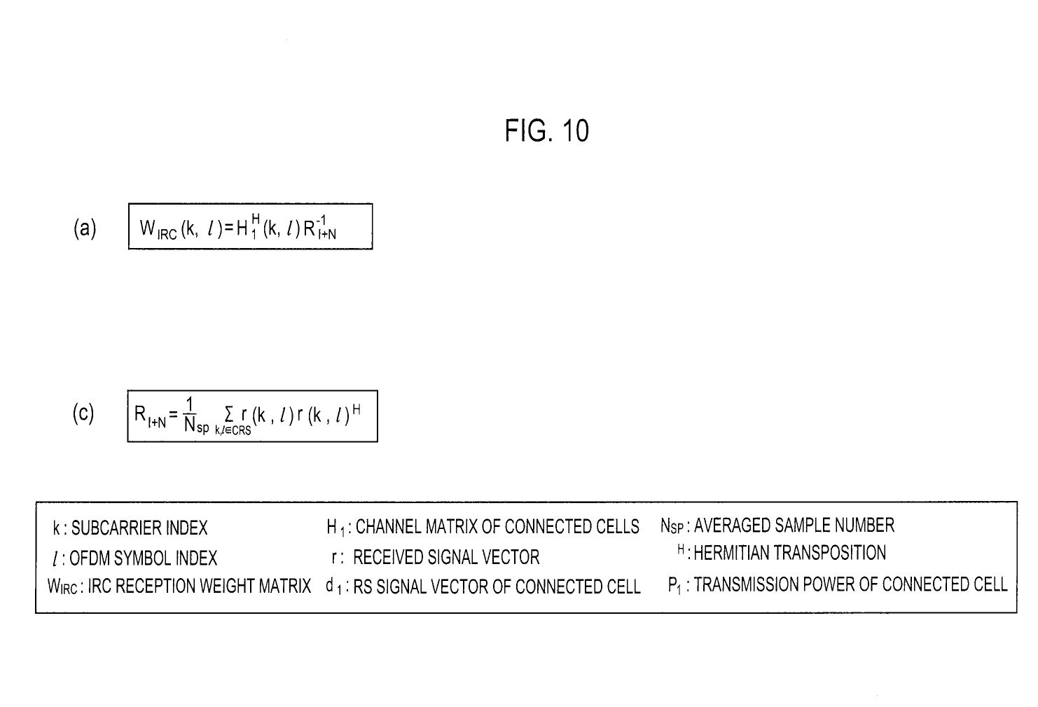

Such a technology is configured to generate an IRC reception weight W_{IRC} (k, l) as illustrated in FIG. 10(a). Furthermore, when generating the IRC reception weight W_{IRC} (k, l), a method of estimating a covariance matrix R_{I+N} based on a data signal (PDSCH) illustrated in FIG. 10(b) is used (see Non Patent Literature 1).

### CITATION LIST

### Non Patent Literature

[NPL 1] 3GPP contribution R4-115213

### SUMMARY OF INVENTION

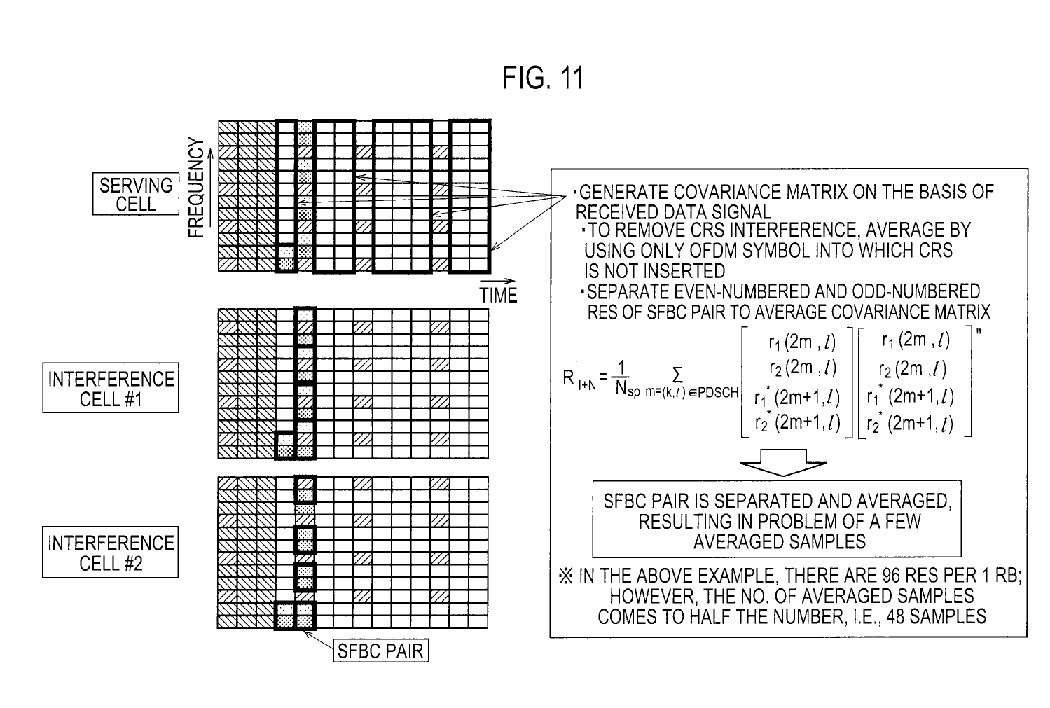

That is, in such a technology, the IRC receiver 10 is configured to generate a covariance matrix R_{I+N} on the basis of a data signal received in a serving cell (cell 1) as illustrated in FIG. 11.

Specifically, in order to prevent the influence of interference due to CRS transmitted in interference cells #1 and #2, the IRC receiver 10 is considered to average only a data signal in an OFDM symbol through which the CRS is not transmitted.

Furthermore, it is considered that the IRC receiver 10 separates and averages even-numbered resource elements of the SFBC pair and odd-numbered resource elements of the SFBC pair, thereby generating the covariance matrix R_{I+N}.

Furthermore, in such a technology, it is considered to separate and average the even-numbered resource elements of the SFBC pair and the odd-numbered resource elements of the SFBC pair, resulting in a problems that the number of samples used in an averaging process is reduced, the accuracy of estimating the covariance matrix R_{I+N} is lowered, it is not possible to generate an accurate IRC reception weight, and the accuracy of suppressing interference in the IRC receiver 10 is lowered.

Therefore, the present invention has been achieved in view of the above-described problems, and an object thereof is to provide a receiver capable of improving the accuracy of estimating a covariance matrix R_{I+N} based on a data signal.

A first characteristic of the present invention is summarized in that a receiver, which receives a data signal and a control signal transmitted using a space frequency block coding scheme, comprising: a covariance matrix estimation unit that estimates a covariance matrix on the basis of the data signal; a covariance matrix generation unit that performs a predetermined process on the estimated covariance matrix; a reception weight generation unit that generates a reception weight by using the covariance matrix subjected to the predetermined process and the control signal; and a signal separation unit that separates the data signal from a received signal by using the generated reception weight and the control signal, wherein the data signal is configured to be transmitted in a space frequency block coding scheme unit including two resource elements, the estimated covariance matrix is configured to include a first covariance matrix including a desired signal component in an even-numbered resource element in the space frequency block coding scheme unit and a second covariance matrix including a desired signal component in an odd-numbered resource element in the space frequency block coding scheme unit, and the covariance matrix generation unit is configured to perform, as the predetermined process, an averaging process on each of elements in the first covariance matrix and elements in the second covariance matrix.

A second characteristic of the present invention is summarized in that a receiver, which receives a data signal and a control signal transmitted using a space frequency block coding scheme, comprising: a covariance matrix estimation unit that estimates a covariance matrix on the basis of the data signal; a covariance matrix generation unit that performs a predetermined process on the estimated covariance matrix; a reception weight generation unit that generates a reception weight by using the covariance matrix subjected to the predetermined process and the control signal; and a signal separation unit that separates the data signal from a received signal by using the generated reception weight and the control signal, wherein the covariance matrix generation unit is configured to perform, as the predetermined process, a process of inserting “0” into an element, which is theoretically to “0”, when channel variation is ignored, in the estimated covariance matrix.

A third characteristic of the present invention is summarized in that a receiver, which receives a data signal and a control signal transmitted using a space frequency block coding scheme, comprising: a covariance matrix estimation unit that estimates a covariance matrix on the basis of the data signal; a covariance matrix generation unit that performs a predetermined process on the estimated covariance matrix; a reception weight generation unit that generates a reception weight by using the covariance matrix subjected to the predetermined process and the control signal; and a signal separation unit that separates the data signal from a received signal by using the generated reception weight and the control signal, wherein the covariance matrix generation unit is configured to perform, as the predetermined process, an averaging process among elements, which are theoretically expressed by one parameter, when channel variation is ignored, in the estimated covariance matrix.

A fourth characteristic of the present invention is summarized in that a receiver, which receives a data signal and a control signal transmitted using a space frequency block coding scheme, comprising: a covariance matrix estimation unit that estimates a covariance matrix on the basis of the data signal; a covariance matrix generation unit that performs a predetermined process on the estimated covariance matrix; a reception weight generation unit that generates a reception weight by using the covariance matrix subjected to the predetermined process and the control signal; and a signal separation unit that separates the data signal from a received signal by using the generated reception weight and the control signal, wherein the covariance matrix generation unit is configured to perform, as the predetermined process, a process of inserting “0” into an element, which is theoretically expressed by one parameter, when channel variation is ignored, in the estimated covariance matrix.

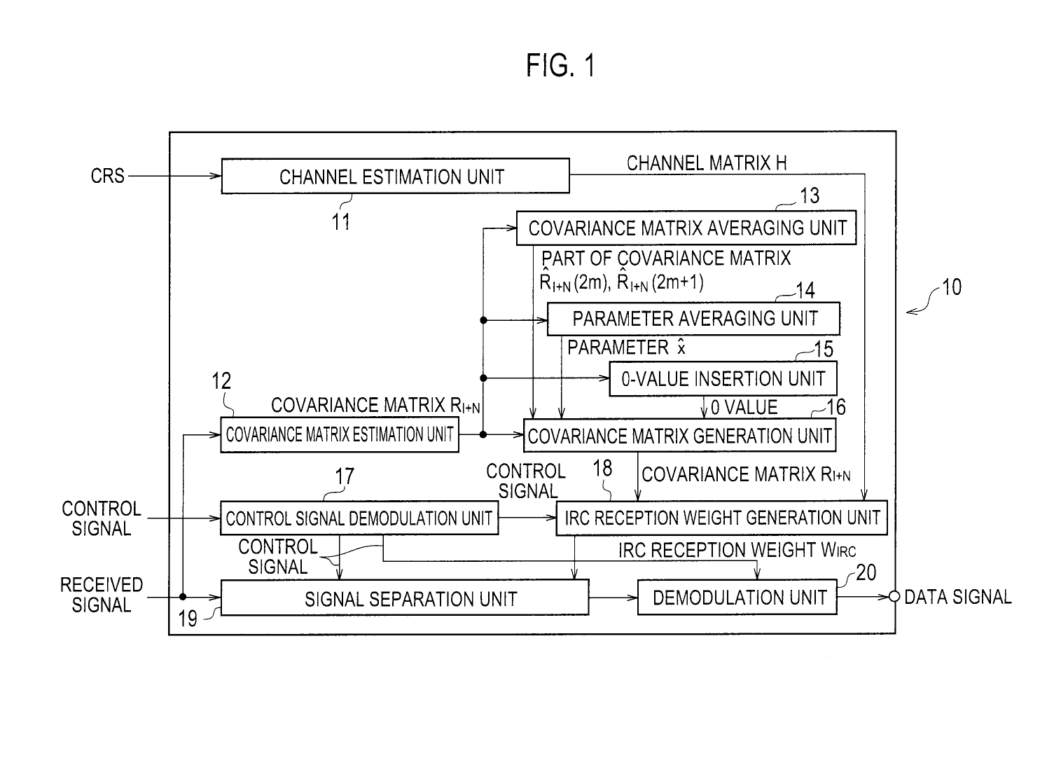

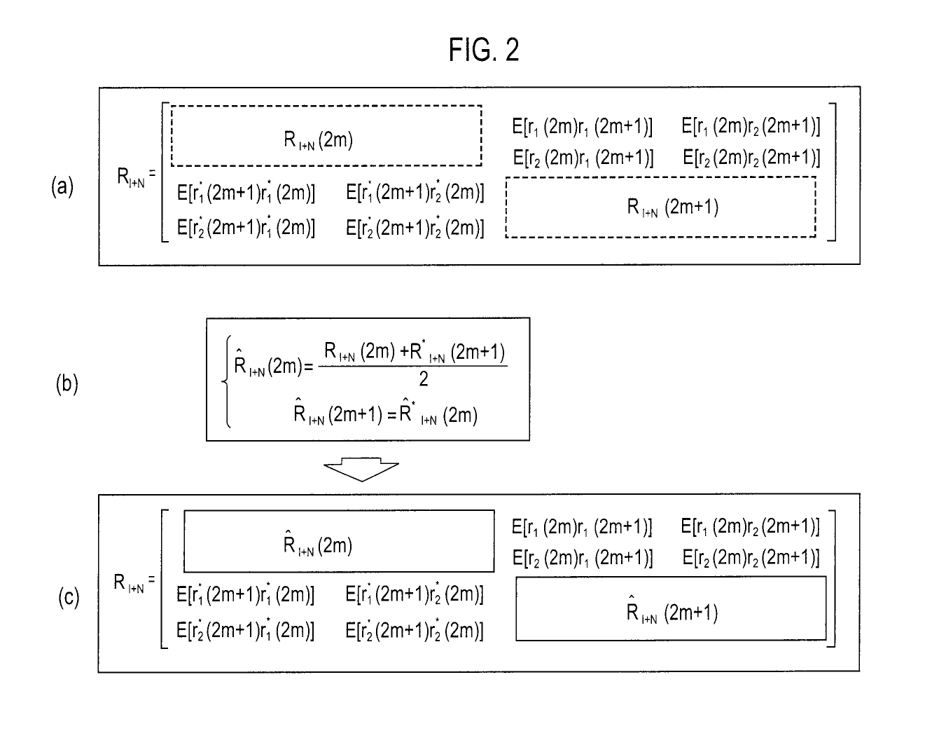

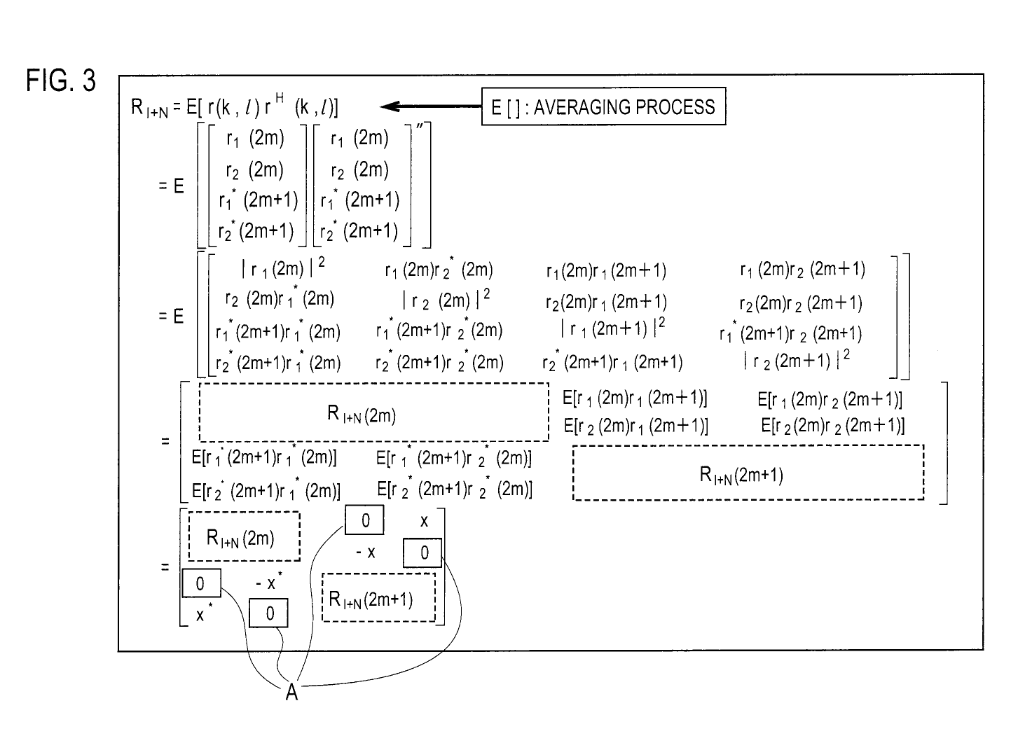

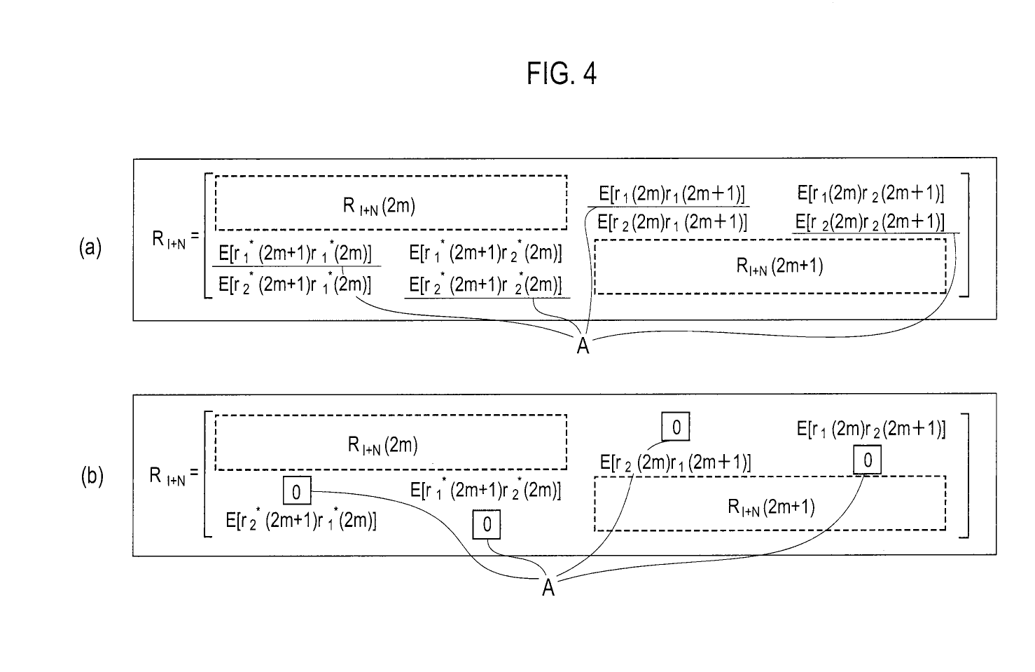

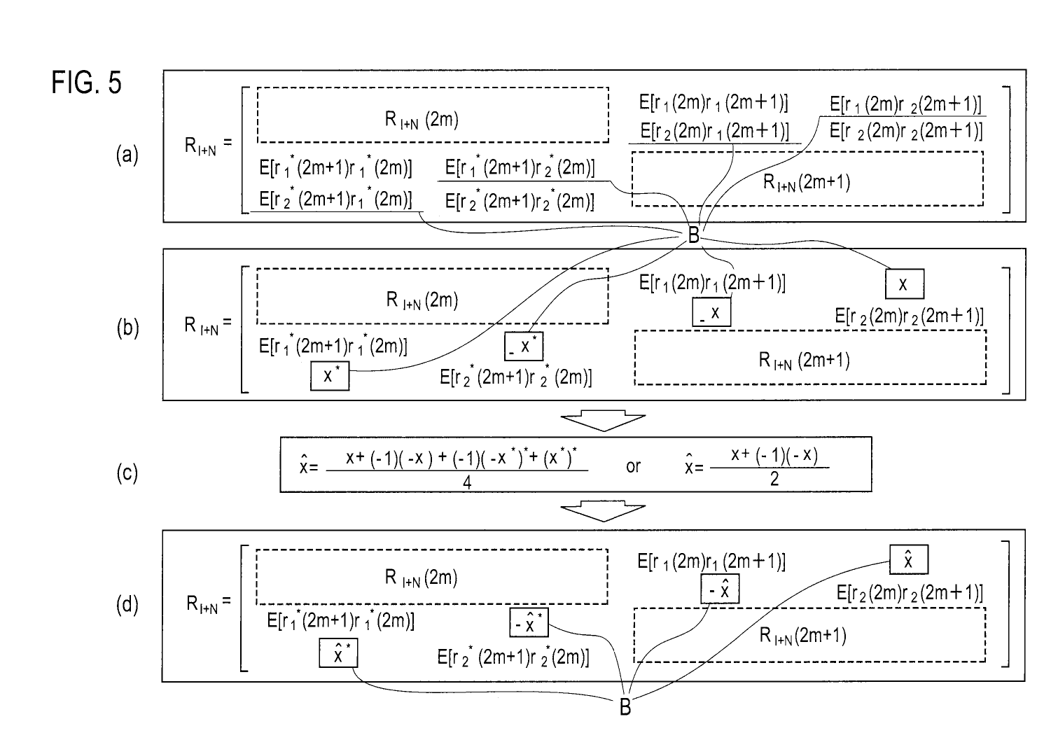

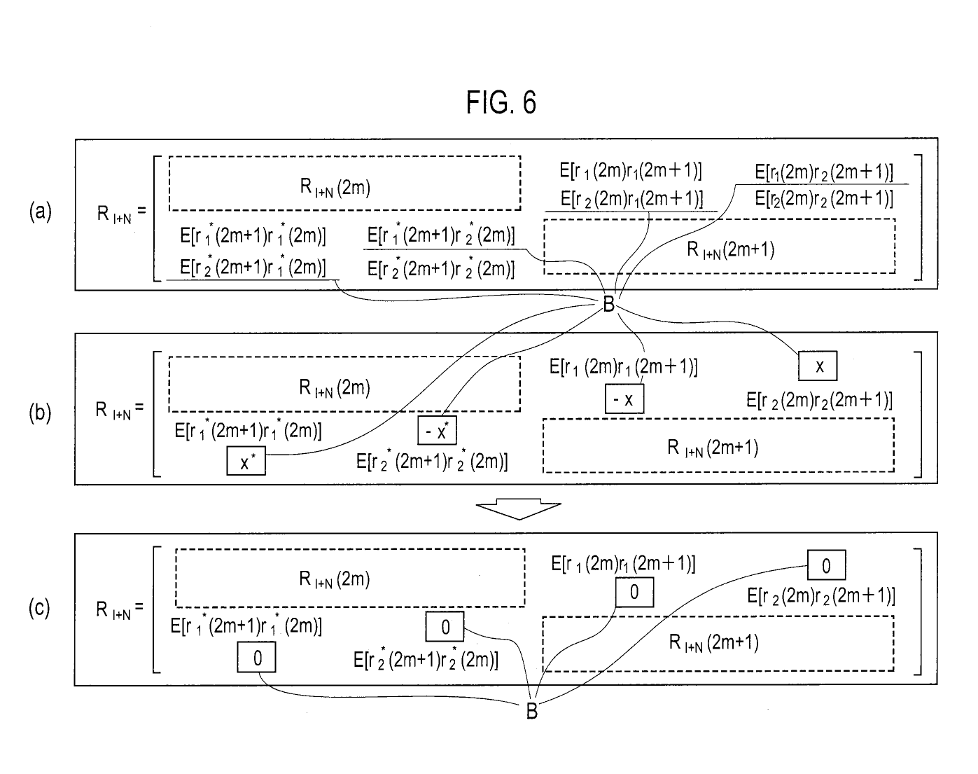

### BRIEF DESCRIPTION OF DRAWINGS

[FIG. 1] FIG. 1 is a functional block diagram of an IRC receiver according to a first embodiment of the present invention.

[FIG. 2] FIG. 2 is a diagram for explaining a method of calculating a covariance matrix in the IRC receiver according to the first embodiment of the present invention.

[FIG. 3] FIG. 3 is a diagram for explaining the method of calculating the covariance matrix in the IRC receiver according to the first embodiment of the present invention.

[FIG. 4] FIG. 4 is a diagram for explaining the method of calculating the covariance matrix in the IRC receiver according to the first embodiment of the present invention.

[FIG. 5] FIG. 5 is a diagram for explaining the method of calculating the covariance matrix in the IRC receiver according to the first embodiment of the present invention.

[FIG. 6] FIG. 6 is a diagram for explaining the method of calculating the covariance matrix in the IRC receiver according to the first embodiment of the present invention.

[FIG. 7] FIG. 7 is a diagram for explaining a conventional technology.

[FIG. 8] FIG. 8 is a diagram for explaining a conventional technology.

[FIG. 9] FIG. 9 is a diagram for explaining a conventional technology.

[FIG. 10] FIG. 10 is a diagram for explaining a conventional technology.

[FIG. 11] FIG. 11 is a diagram for explaining a conventional technology.

### DESCRIPTION OF EMBODIMENTS

### Mobile Communication System According to First Embodiment of the Present Invention

With reference to FIG. 1 to FIG. 6, an IRC receiver 10 according to a first embodiment of the present invention will be described.

As illustrated in FIG. 1, the IRC receiver 10 according to the present embodiment includes a channel estimation unit 11, a covariance matrix estimation unit 12, a covariance matrix averaging unit 13, a parameter averaging unit 14, a 0-value insertion unit 15, a covariance matrix generation unit 16, a control signal demodulation unit 17, an IRC reception weight generation unit 18, a signal separation unit 19, and a demodulation unit 20.

The channel estimation unit 11 is configured to perform a channel estimation process on the basis of CRS received from a serving cell (cell 1), so as to estimate (calculate) a channel matrix H.

The covariance matrix estimation unit 12 is configured to estimate a covariance matrix R_{I+N} on the basis of a data signal. Specifically, the covariance matrix estimation unit 12 is configured to estimate (calculate) the covariance matrix R_{I+N} by using Equation illustrated in FIG. 10(b).

The covariance matrix R_{I+N} estimated (calculated) by the covariance matrix estimation unit 12 includes a first covariance matrix R_{I+N} (2m) including a desired signal component in even-numbered resource elements in an SFBC pair and a second covariance matrix R_{I+N} (2m+1) including a desired signal component in odd-numbered resource elements in the SFBC pair as illustrated in FIG. 2(a).

Furthermore, when an SFBC scheme is used, it has been known that a relation of R_{I+N} (2m)=R*_{I+N} (2m+1) is theoretically satisfied.

In consideration of this point, the covariance matrix averaging unit 13 is configured to perform an averaging process on each of elements in the first covariance matrix R_{I+N} (2m) and elements in the second covariance matrix R_{I+N} (2m+1) by using Equation illustrated in FIG. 2(b). As a result,

\tilde{R}_{I+N}(2m), \tilde{R}_{I+N}(2m+1) [Math. 1]

is acquired.

The covariance matrix generation unit 16 may be configured to perform a process (a predetermined process) of changing each of the elements in the first covariance matrix R_{I+N} (2m) and the elements in the second covariance matrix R_{I+N} (2m+1), which are included in the covariance matrix R_{I+N} estimated (calculated) by the covariance matrix estimation unit 12, into elements of Equation 2 received from the covariance matrix averaging unit 13,

\tilde{R}_{I+N}(2m),\tilde{R}_{I+N}(2m+1) [Math. 2]

as illustrated in FIG. 2(c).

The averaging process using Equation illustrated in FIG. 2(b) is performed, and thereby, it is possible to obtain an effect equivalent to that which is obtained when the number of samples that are used in the averaging process is doubled when estimating the covariance matrix R_{I+N}, and to improve the accuracy of estimating the covariance matrix R_{I+N} based on the data signal.

Furthermore, the covariance matrix R_{I+N}, when channel variation is ignored, is theoretically expressed by Equation illustrated in FIG. 3. Furthermore, as illustrated in FIG. 3, elements A in the covariance matrix R_{I+N} are known to be theoretically “0” when the channel variation is ignored.

In consideration of this point, the 0-value insertion unit 15 is configured to instruct the covariance matrix generation unit 16 to insert “0” into the elements A, which are theoretically to “0”, when the channel variation is ignored, in the covariance matrix R_{I+N} estimated by the covariance matrix estimation unit 12 and illustrated in FIG. 4(a).

The covariance matrix generation unit 16 may also be configured to perform a process (a predetermined process) of inserting “0” into the elements A in the covariance matrix R_{I+N}, which is estimated by the covariance matrix estimation unit 12 and is illustrated in FIG. 4(a), in response to the instruction from the 0-value insertion unit 15, as illustrated in FIG. 4(b).

The predetermined process illustrated in FIG. 4(b) is performed, that is, “0” is inserted into the elements A to be theoretically to “0”, so that it is possible to improve the accuracy of estimating the covariance matrix R_{I+N} based on the data signal while reducing a calculation amount.

Furthermore, as illustrated in FIG. 5(a) and FIG. 5(b), elements B in the covariance matrix R_{I+N} estimated by the covariance matrix estimation unit 12 are theoretically expressed by one parameter x when the channel variation is ignored.

In consideration of this point, the parameter averaging unit 14 is configured to perform an averaging process among the aforementioned elements B by using Equation illustrated in FIG. 5(c). As a result,

\tilde{X} [Math. 3]

is acquired.

The covariance matrix generation unit 16 may also be configured to change each of the elements B, which are included in the covariance matrix R_{I+N} estimated (calculated) by the covariance matrix estimation unit 12, on the basis of Equation 4

\tilde{X} [Math. 4]

received from the parameter averaging unit 14, as illustrated in FIG. 5(d).

The averaging process using Equation illustrated in FIG. 5(c) is performed, so that it is possible to obtain an effect equivalent to an increase in the number of samples that are used in the averaging process when estimating the covariance matrix R_{I+N}, and to improve the accuracy of estimating the covariance matrix R_{I+N} based on the data signal.

Alternatively, the covariance matrix generation unit 16 may also be configured to perform a process (a predetermined process) of inserting “0” into the elements B, which are included in the covariance matrix R_{I+N} estimated (calculated) by the covariance matrix estimation unit 12, in response to the instruction from the 0-value insertion unit 15 as illustrated in FIG. 6(c).

The predetermined process illustrated in FIG. 6(c) is performed, that is, “0” is inserted into the elements B, so that it is possible to improve the accuracy of estimating the covariance matrix R_{I+N} based on the data signal while reducing a calculation amount.

In addition, the covariance matrix generation unit 16 may also be configured to perform two or more combinations of the process illustrated in FIG. 2(c), the process illustrated in FIG. 4(b), the process illustrated in FIG. 5(d), and the process illustrated in FIG. 6(c).

The control signal demodulation unit 17 is configured to perform a demodulation process on a control signal received from the serving cell (cell 1).

The IRC reception weight generation unit 18 is configured to generate an IRC reception weight W_{IRC} on the basis of the channel matrix H received from the channel estimation unit 11, the control signal received from the control signal demodulation unit 15, and the covariance matrix R_{I+N} (the covariance matrix R_{I+N} subjected to the predetermined process) received from the covariance matrix generation unit 16.

Specifically, the IRC reception weight generation unit 18 is configured to substitute the channel matrix H received from the channel estimation unit 11 and the covariance matrix R_{I+N} received from the covariance matrix generation unit 16 into Equation illustrated in FIG. 10(a), so as to generate the IRC reception weight W_{IRC}.

The signal separation unit 19 is configured to perform a signal separation process on a received signal from the serving cell (cell 1) on the basis of the control signal received from the control signal demodulation unit 17 and the IRC reception weight W_{IRC} received from the IRC reception weight generation unit 18.

The demodulation unit 20 is configured to perform a demodulation process on a signal received from the signal separation unit 19 on the basis of the control signal received from the control signal demodulation unit 17 and the IRC reception weight W_{IRC} received from the IRC reception weight generation unit 18 so as to output a data signal.

In accordance with the IRC receiver 10 according to the present embodiment, it is possible to improve the accuracy of estimating the covariance matrix R_{I+N} based on the data signal by using the process illustrated in FIG. 2(c), the process illustrated in FIG. 4(b), the process illustrated in FIG. 5(d), the process illustrated in FIG. 6(c), and the like.

In the aforementioned embodiment, an example, in which the number of antennas of the IRC receiver 10 is “2”, has been described. However, the present invention can be performed regardless of the number of the antennas of the IRC receiver 10.

The characteristics of the present embodiment as described above may be expressed as follows:

A first characteristic of the present embodiment is summarized that an IRC receiver 10, which receives a data signal and a control signal transmitted using an SFBC (Space Frequency Block Coding) scheme, includes: a covariance matrix estimation unit 12 that estimates a covariance matrix R_{I+N} on the basis of the data signal; a covariance matrix averaging unit 13 and a covariance matrix generation unit 16 that perform a predetermined process on the estimated covariance matrix R_{I+N}; an IRC reception weight generation unit 18 that generates an IRC reception weight W_{IRC} by using the covariance matrix R_{I+N} subjected to the predetermined process and the control signal; and a signal separation unit 19 that separates the data signal from a received signal by using the generated IRC reception weight W_{IRC} and the control signal, wherein the data signal is configured to be transmitted in an SFBC pair (Space Frequency Block Coding scheme unit) including two resource elements, the estimated covariance matrix R_{I+N} is configured to include a first covariance matrix R_{I+N} (2m) including a desired signal component in even-numbered resource elements in the SFBC pair and a second covariance matrix R_{I+N} (2m+1) including a desired signal component in odd-numbered resource elements in the SFBC pair, and the covariance matrix averaging unit 13 and the covariance matrix generation unit 16 are configured to perform, as the aforementioned predetermined process, an averaging process on each of elements in the first covariance matrix R_{I+N} (2m) and elements in the second covariance matrix R_{I+N} (2m+1).

A second characteristic of the present embodiment is summarized that an IRC receiver 10, which receives a data signal and a control signal transmitted using an SFBC scheme, includes: a covariance matrix estimation unit 12 that estimates a covariance matrix R_{I+N} on the basis of the data signal; a 0-value insertion unit 15 and a covariance matrix generation unit 16 that perform a predetermined process on the estimated covariance matrix R_{I+N}; an IRC reception weight generation unit 18 that generates an IRC reception weight W_{IRC} by using the covariance matrix R_{I+N} subjected to the predetermined process and the control signal; and a signal separation unit 19 that separates the data signal from a received signal by using the generated IRC reception weight W_{IRC} and the control signal, wherein the 0-value insertion unit 15 and the covariance matrix generation unit 16 are configured to perform, as the aforementioned predetermined process, a process of inserting “0” into elements A, which are theoretically to “0” when channel variation is ignored, in the estimated covariance matrix R_{I+N}.

A third characteristic of the present embodiment is summarized that an IRC receiver 10, which receives a data signal and a control signal transmitted using an SFBC scheme, include: a covariance matrix estimation unit 12 that estimates a covariance matrix R_{I+N} on the basis of the data signal; a parameter averaging unit 14 and a covariance matrix generation unit 16 that perform a predetermined process on the estimated covariance matrix R_{I+N}; an IRC reception weight generation unit 18 that generates an IRC reception weight W_{IRC} by using the covariance matrix R_{I+N} subjected to the predetermined process and the control signal; and a signal separation unit 19 that separates the data signal from a received signal by using the generated IRC reception weight W_{IRC} and the control signal, wherein the parameter averaging unit 14 and the covariance matrix generation unit 16 are configured to perform, as the aforementioned predetermined process, an averaging process among elements B, which are theoretically expressed by one parameter x when channel variation is ignored, in the estimated covariance matrix R_{I+N}.

A fourth characteristic of the present embodiment is summarized that an IRC receiver 10, which receives a data signal and a control signal transmitted using an SFBC scheme, includes: a covariance matrix estimation unit 12 that estimates a covariance matrix R_{I+N} on the basis of the data signal; a 0-value insertion unit 15 and a covariance matrix generation unit 16 that perform a predetermined process on the estimated covariance matrix R_{I+N}; an IRC reception weight generation unit 18 that generates an IRC reception weight W_{IRC} by using the covariance matrix R_{I+N} subjected to the predetermined process and the control signal; and a signal separation unit 19 that separates the data signal from a received signal by using the generated IRC reception weight W_{IRC} and the control signal, wherein the 0-value insertion unit 15 and the covariance matrix generation unit 16 are configured to perform, as the aforementioned predetermined process, a process of inserting “0” into an element, which is theoretically expressed by one parameter x when channel variation is ignored, in the estimated covariance matrix R_{I+N}.

In addition, the operation of the above-mentioned IRC receiver 10 may be implemented by hardware, may also be implemented by a software module executed by a processor, or may further be implemented by the combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. The ASIC may be arranged in the IRC receiver 10. Furthermore, such a storage medium and processor may be arranged in the IRC receiver 10 as discrete components.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

In addition, the entire content of Japanese Patent Application No. 2011-242911 (filed on Nov. 4, 2011) is incorporated in the present specification by reference.

### INDUSTRIAL APPLICABILITY

As described above, according to the present invention, it is possible to provide a receiver capable of improving the accuracy of estimating a covariance matrix R_{I+N} based on a data signal.

### REFERENCE SIGNS LIST

10 . . . IRC receiver
11 . . . Channel estimation unit
12 . . . Covariance matrix estimation unit
13 . . . Covariance matrix averaging unit
14 . . . Parameter averaging unit
15 . . . 0-value insertion unit
16 . . . Covariance matrix generation unit
17 . . . Control signal demodulation unit
18 . . . IRC reception weight generation unit
19 . . . Signal separation unit
20 . . . Demodulation unit

1. A receiver, which receives a data signal and a control signal transmitted using a space frequency block coding scheme, comprising:
a covariance matrix estimation unit that estimates a covariance matrix on the basis of the data signal;
a covariance matrix generation unit that performs a predetermined process on the estimated covariance matrix;
a reception weight generation unit that generates a reception weight by using the covariance matrix subjected to the predetermined process and the control signal; and
a signal separation unit that separates the data signal from a received signal by using the generated reception weight and the control signal,
wherein the data signal is configured to be transmitted in a space frequency block coding scheme unit including two resource elements,
the estimated covariance matrix is configured to include a first covariance matrix including a desired signal component in an even-numbered resource element in the space frequency block coding scheme unit and a second covariance matrix including a desired signal component in an odd-numbered resource element in the space frequency block coding scheme unit, and
the covariance matrix generation unit is configured to perform, as the predetermined process, an averaging process on each of elements in the first covariance matrix and elements in the second covariance matrix.

2. A receiver, which receives a data signal and a control signal transmitted using a space frequency block coding scheme, comprising:
a covariance matrix estimation unit that estimates a covariance matrix on the basis of the data signal;
a covariance matrix generation unit that performs a predetermined process on the estimated covariance matrix;
a reception weight generation unit that generates a reception weight by using the covariance matrix subjected to the predetermined process and the control signal; and
a signal separation unit that separates the data signal from a received signal by using the generated reception weight and the control signal,
wherein the covariance matrix generation unit is configured to perform, as the predetermined process, a process of inserting “0” into an element, which is theoretically to “0”, when channel variation is ignored, in the estimated covariance matrix.

3. A receiver, which receives a data signal and a control signal transmitted using a space frequency block coding scheme, comprising:
a covariance matrix estimation unit that estimates a covariance matrix on the basis of the data signal;
a covariance matrix generation unit that performs a predetermined process on the estimated covariance matrix;
a reception weight generation unit that generates a reception weight by using the covariance matrix subjected to the predetermined process and the control signal; and
a signal separation unit that separates the data signal from a received signal by using the generated reception weight and the control signal,
wherein the covariance matrix generation unit is configured to perform, as the predetermined process, an averaging process among elements, which are theoretically expressed by one parameter, when channel variation is ignored, in the estimated covariance matrix.

4. A receiver, which receives a data signal and a control signal transmitted using a space frequency block coding scheme, comprising:
a covariance matrix estimation unit that estimates a covariance matrix on the basis of the data signal;
a covariance matrix generation unit that performs a predetermined process on the estimated covariance matrix;
a reception weight generation unit that generates a reception weight by using the covariance matrix subjected to the predetermined process and the control signal; and
a signal separation unit that separates the data signal from a received signal by using the generated reception weight and the control signal,
wherein the covariance matrix generation unit is configured to perform, as the predetermined process, a process of inserting “0” into an element, which is theoretically expressed by one parameter, when channel variation is ignored, in the estimated covariance matrix.
